(19) United States
(12) Patent Application Publication
(10) Pub. No.: US 2017/0031699 A1
(43) Pub. Date: Feb. 2, 2017

(54) Multiprocessing Within a Storage Array System Executing Controller Firmware Designed for a Uniprocessor Environment

(71) Applicant: NetApp, Inc., Sunnyvale, CA (US)

(72) Inventors: Arindam Banerjee, Superior, CO (US); Martin Jess, Boulder, CO (US)

(21) Appl. No.: 14/811,972

(22) Filed: Jul. 29, 2015

(51) Int. Cl. G06F 9/455; G06F 12/08

(52) U.S. Cl. CPC G06F 9/45558; G06F 12/0895; G06F 2212/50; G06F 2212/604; G06F 2009/45579; G06F 2009/45583

(57) ABSTRACT

Systems, devices, and methods are provided for sharing host resources in a multiprocessor storage array, the multiprocessor storage array running controller firmware designed for a uniprocessor environment. In some aspects, one or more virtual machines can be initialized by a virtual machine manager or a hypervisor in the storage array system. Each of the one or more virtual machines implement an instance of the controller firmware designed for a uniprocessor environment. The virtual machine manager or hypervisor can assign processing devices within the storage array system to each of the one or more virtual machines. The virtual machine manager or hypervisor can also assign virtual functions to each of the virtual machines. The virtual machines can concurrently access one or more I/O devices, such as physical storage devices, by writing to and reading from the respective virtual functions.

### TECHNICAL FIELD

The present disclosure relates generally to storage array systems and more specifically to methods and systems for sharing host resources in a multiprocessor storage array with controller firmware designed for a uniprocessor environment.

### BACKGROUND

Business entities and consumers are storing an ever increasing amount of digital data. For example, many commercial entities are in the process of digitizing their business records and other data, for example by hosting large amounts of data on web servers, file servers, and other databases. Techniques and mechanisms that facilitate efficient and cost effective storage of vast amounts of digital data are being implemented in storage array systems. A storage array system can include and be connected to multiple storage devices, such as physical hard disk drives, networked disk drives on backend controllers, as well as other media. One or more client devices can connect to a storage array system to access stored data. The stored data can be divided into numerous data blocks and maintained across the multiple storage devices connected to the storage array system.

The controller firmware code (also referred to as the operating system) for a storage array system is typically designed to operate in a uniprocessor environment as a single threaded operating system. The hardware-software architecture for a uniprocessor storage controller with a single threaded operating system can be built around a non-preemptive model, where a task initiated by the single threaded firmware code (e.g., to access particular storage resources of connected storage devices) generally cannot be scheduled out of the CPU involuntarily. A non-preemptive model can also be referred to as voluntary pre-emption. In a voluntary pre-emption/non-preemptive model, data structures in the storage array controller are not protected from concurrent access. Lack of protection from concurrent access is typically not a problem for storage controllers with single threaded firmware, as access to storage resources can be scheduled by the single threaded operating system. Interrupts on the CPU core are disabled in a storage controller with a single threaded operating system while running critical sections of the code, protecting conflicting access of the data structures. To run an operating system on a multiprocessor storage controller, however, a single threaded operating system would need to be redesigned to be multiprocessor capable in order to avoid allowing conflicting access to data structures. A multiprocessor storage controller can include single multi-core processors and multiple single-core processors. Multiprocessor storage arrays running single threaded operating systems are currently not available within current architecture because, in a voluntary pre-emption architecture, two tasks running on different processors or different processing cores can access the same data structure concurrently and this would result in conflicting access to the data structures. Redesigning a storage operating system to be multiprocessor capable would require a significant software architecture overhaul. It is therefore desirable to have a new method and system that can utilize storage controller firmware designed for a uniprocessor architecture, including a uniprocessor operating system, and that can be scaled to operate on storage array systems with multiple processing cores.

### SUMMARY

Systems and methods are described for sharing host resources in a multiprocessor storage array system, where the storage array system executes controller firmware designed for a uniprocessor environment. Multiprocessing in a storage array system can be achieved by executing multiple instances of the single threaded controller firmware in respective virtual machines, each virtual machine assigned to a physical processing device within the storage array system.

For example, in one embodiment, a method is provided for sharing host resources in a multiprocessor storage array system. The method can include the step of initializing, in a multiprocessor storage system, one or more virtual machines. Each of the one or more virtual machines implement respective instances of an operating system designed for a uniprocessor environment. The method can include respectively assigning processing devices to each of the one or more virtual machines. The method can also include respectively assigning virtual functions in an I/O controller to each of the one or more virtual machines The I/O controller can support multiple virtual functions, each of the virtual functions simulating the functionality of a complete and independent I/O controller. The method can further include accessing in parallel, by the one or more virtual machines, one or more host or storage I/O devices via the respective virtual functions. For example, each virtual function can include a set of virtual base address registers. The virtual base address registers for each virtual function can be mapped to the hardware resources of connected host or storage I/O devices. A virtual machine can be configured to read from and write to the virtual base address registers included in the assigned virtual function. In one aspect, a virtual function sorting/routing layer can route communication between the connected host or storage I/O devices and the virtual functions. Accordingly, each virtual machine can share access, in parallel, to connected host or storage I/O devices via the respective virtual functions. As each virtual machine can be configured to execute on a respective processing device, the method described above allows the processing devices on the storage array system to share access, in parallel, with connected host devices while executing instances of an operating system designed for a uniprocessor environment.

In another embodiment, a multiprocessor storage system configured for providing shared access to connected host resources is provided. The storage system can include a computer readable memory including program code stored thereon. Upon execution of the program code, the computer readable memory can initiate a virtual machine manager. The virtual machine manager can be configured to provide a first virtual machine. The first virtual machine executes a first instance of a storage operating system designed for a uniprocessor environment. The first virtual machine is also assigned to first virtual function. The virtual machine manager is also configured to provide a second virtual machine. The second virtual machine executes a second instance of the operating system. The second virtual machine is also assigned to a second virtual function. The first virtual machine and the second virtual machine share access to one or more connected host devices via the first virtual function and the second virtual function. Each virtual function can include a set of base address registers. Each virtual machine can read from and write to the base address registers included in its assigned virtual function. In one aspect, a virtual function sorting/routing layer can route communication between the connected host devices and the virtual functions. Accordingly, each virtual machine can share access, in parallel, to connected host or storage I/O devices via the respective virtual functions. The storage system can also include a first processing device and a second processing device. The first processing device executes operations performed by the first virtual machine and the second processing device executes operations performed by the second virtual machine. As each virtual machine executes on a respective processing device, the multiprocessor storage system described above allows the processing devices on the storage array system to share access, in parallel, with connected host or storage I/O devices while executing instances of an operating system designed for a uniprocessor environment.

In another embodiment, a non-transitory computer readable medium is provided. The non-transitory computer readable medium can include program code that, upon execution, initializes, in a multiprocessor storage system, one or more virtual machines. Each virtual machine implements a respective instance of an operative system designed for a uniprocessor environment. The program code also, upon execution, assigns processing devices to each of the one or more virtual machines and assigns virtual functions to each of the one or more virtual machines. The program code further, upon execution, causes the one or more virtual machines to access one or more host devices in parallel via the respective virtual functions. Implementing the non-transitory computer readable medium as described above on a multiprocessor storage system allows the multiprocessor storage system to access connected host or storage I/O devices in parallel while executing instances of an operating system designed for a uniprocessor environment.

These illustrative examples are mentioned not to limit or define the disclosure, but to provide examples to aid understanding thereof. Additional aspects and examples are discussed in the Detailed Description, and further description is provided there.

### BRIEF DESCRIPTION OF THE DRAWINGS

FIG. 1 is a block diagram depicting an example of a multiprocessor storage array system running multiple virtual machines, each virtual machine assigned to a respective processing device, in accordance with certain embodiments.

FIG. 2 is a block diagram illustrating an example of a hardware-software interface architecture of the storage array system depicted in FIG. 1, in accordance with certain embodiments.

FIG. 3 is a flowchart depicting an example method for providing multiple virtual machines with shared access to connected host devices, in accordance with certain embodiments.

FIG. 4 is a block diagram depicting an example of a primary controller board and an alternate controller board for failover purposes, in accordance with certain embodiments.

### DETAILED DESCRIPTION

Embodiments of the disclosure described herein are directed to systems and methods for multiprocessing input/output (I/O) resources and processing resources in a storage array that runs an operating system designed for a uniprocessor (single processor) environment. An operating system designed for a uniprocessor environment can also be referred to as a single threaded operating system. Multiprocessing in a storage array with a single threaded operating system can be achieved by initializing multiple virtual machines in a virtualized environment, each virtual machine assigned to a respective physical processor in the multiprocessor storage array, and each virtual machine executing a respective instance of the single threaded operating system. The single threaded storage controller operating system can include the system software that manages input/output (“I/O”) processing of connected host devices and of connected storage devices. Thus, each of the virtual machines can perform I/O handling operations in parallel with the other virtual machines, thereby imparting multiprocessor capability for a storage system with controller firmware designed for a uniprocessor environment.

For example, host devices coupled to the storage system controller (such as computers that can control and drive 10 operations of the storage system controller) and backend storage devices can be coupled to the storage system controller via host I/O controllers and storage I/O controllers, respectively. The storage devices coupled to the storage system controller via the storage I/O controllers can be provisioned and organized into multiple logical volumes. The logical volumes can be assigned to multiple virtual machines executing in memory. Storage resources from multiple connected storage devices can be combined and assigned to a running virtual machine as a single logical volume. A logical volume may have a single address space, capacity which may exceed the capacity of any single connected storage device, and performance which may exceed the performance of a single storage device. Each virtual machine, executing a respective instance of the single threaded storage controller operating system, can be assigned one or more logical volumes, providing applications running on the virtual machines parallel access to the storage resources. Executing tasks can thereby concurrently access the connected storage resources without conflict, even in a voluntary pre-emption architecture.

Each virtual machine can access the storage resources in coupled storage devices via a respective virtual function. Virtual functions allow the connected host devices to be shared among the running virtual machines using Single Root I/O Virtualization (“SR-IOV”). SR-IOV defines how a single physical I/O controller can be virtualized as multiple logical I/O controllers. A virtual function thus represents a physical I/O controller. For example, a virtual function can be associated with the configuration space of a connected host IO controller, connected storage I/O controller, or combined configuration spaces of multiple IO controllers. The virtual functions can include virtualized base address registers that map to the physical registers of a host device. Thus, virtual functions provide full PCI-e functionality to assigned virtual machines through virtualized base address registers. The virtual machine can communicate with the connected host device by writing to and reading from the virtualized base address registers in the assigned virtual function.

By implementing SR-IOV, an SR-IOV capable I/O controller can include multiple virtual functions, each virtual function assigned to a respective virtual machine running in the storage array system. The virtualization module can share an SR-IOV compliant host device or storage device among multiple virtual machines by mapping the configuration space of the host device or storage device to the virtual configuration spaces included in the virtual functions assigned to each virtual machine.

The embodiments described herein thus provide methods and systems for multiprocessing without requiring extensive design changes to single threaded firmware code designed for a uniprocessor system, making a disk subsystem running a single threaded operating system multiprocessor/multicore capable. The aspects described herein also provide a scalable model that can scale with the number of processor cores available in the system, as each processor core can run a virtual machine executing an additional instance of the single threaded operating system. If the I/O load on the storage system is low, then the controller can run fewer virtual machines to avoid potential processing overhead. As the I/O load on the storage system increases, the controller can spawn additional virtual machines dynamically to handle the extra load. Thus, the multiprocessing capability of the storage system can be scaled by dynamically increasing the number of virtual machines that can be hosted by the virtualized environment as the I/O load of existing storage volumes increases. Additionally, if one virtual machine has a high I/O load, any logical volume provisioned from storage devices coupled to the storage system and presented to the virtual machine can be migrated to a virtual machine with a lighter I/O load.

The embodiments described herein also allow for Quality of Service (“QoS”) grouping across applications executing on the various logical volumes in the storage array system. Logical volumes with similar QoS attributes can be grouped together within a virtual machine that is tuned for a certain set of QoS attributes. For example, the resources of a storage array system can be shared among remote devices running different applications, such as Microsoft Exchange and Oracle Server. Both Microsoft Exchange and Oracle Server can access storage on the storage array system. Microsoft Exchange and Oracle Server can require, however, different QoS attributes. A first virtual machine, optimized for a certain set of QoS attributes can be used to host Microsoft Exchange. A second virtual machine, optimized for a different set of QoS attributes (attributes aligned with Oracle Server) can host Oracle Server.

Detailed descriptions of certain examples are discussed below. These illustrative examples provided above are given to introduce the general subject matter discussed herein and are not intended to limit the scope of the disclosed concepts. The following sections describe various additional aspects and examples with reference to the drawings in which like numerals indicate like elements, and directional descriptions are used to describe the illustrative examples but, like the illustrative examples, should not be used to limit the present disclosure.

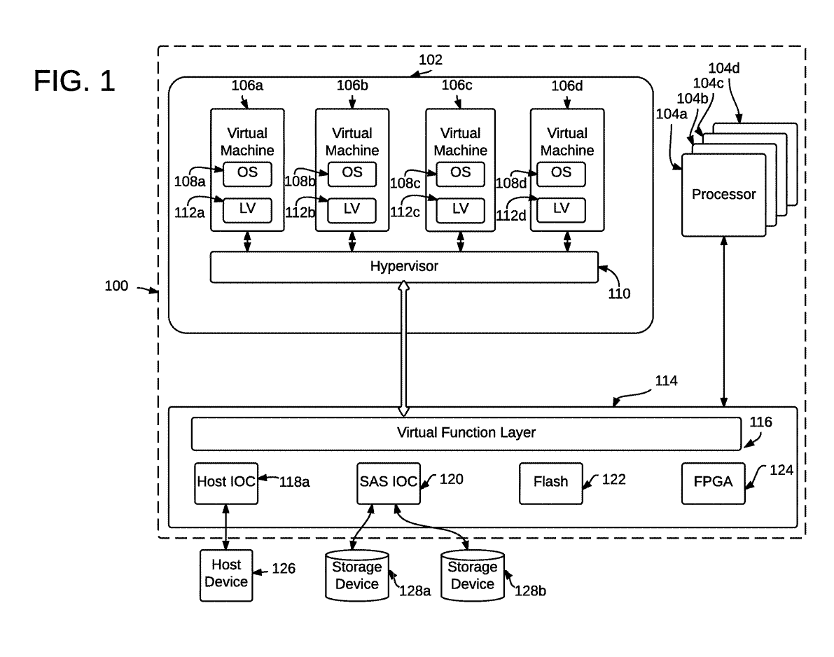

FIG. 1 depicts a block diagram showing an example of a storage array system 100 according to certain aspects. The storage array system 100 can be part of a storage area network (“SAN”) storage array. Non-limiting examples of a SAN storage array can include the Netapp E2600, E5500, and E5400 storage systems. The multiprocessor storage array system 100 can include processors 104a-d, a memory device 102, and an sr-IOV layer 114 for coupling additional hardware. The sr-IOV layer 114 can include, for example, sr-IOV capable controllers such as a host I/O controller (host IOC) 118 and a Serial Attached SCSI (SAS) I/O controller (SAS IOC) 120. The host IOC 118 can include I/O controllers such as Fiber Channel, Internet Small Computer System Interface (iSCSI), or Serial Attached SCSI (SAS) I/O controllers. The host IOC 118 can be used to couple host devices, such as host device 126, with the storage array system 100. Host device 126 can include computer servers (e.g., hosts) that connect to and drive 10 operations of the storage array system 100. While only one host device 126 is shown for illustrative purposes, multiple host devices can be coupled to the storage array system 100 via the host IOC 118. The SAS IOC 120 can be used to couple data storage devices 128a-b to the storage array system 100. For example, data storage devices 128a-b can include solid state drives, hard disk drives, and other storage media that may be coupled to the storage array system 100 via the SAS IOC 120. The SAS IOC can be used to couple multiple storage devices to the storage array system 100. The host devices 126 and storage devices 128a-b can generally be referred to as “I/O devices.” The sr-IOV layer 114 can also include a flash memory host device 122 and an FPGA host device 124. The flash memory host device 122 can store any system initialization code used for system boot up. The FPGA host device 124 can be used to modify various configuration settings of the storage array system 100.

The processors 104a-d shown in FIG. 1 can be included as multiple processing cores integrated on a single integrated circuit ASIC. Alternatively, the processors 104a-d can be included in the storage array system 100 as separate integrated circuit ASICs, each hosting a one or more processing cores. The memory device 102 can include any suitable computer-readable medium. The computer-readable medium can include any electronic, optical, magnetic, or other storage device capable of providing a processor with computer-readable instructions or other program code. Non-limiting examples of a computer-readable medium include a floppy disk, CD-ROM, DVD, magnetic disk, memory chip, ROM, RAM, an ASIC, a configured processor, optical storage, magnetic tape or other magnetic storage, or any other medium from which a computer processor can read program code. The program code may include processor-specific instructions generated by a compiler and/or an interpreter from code written in any suitable computer-programming language, including, for example, C, C++, C#, Visual Basic, Java, Python, Perl, JavaScript, ActionScript, as well as assembly level code.

The memory device 102 can include program code for initiating a hypervisor 110 in the storage array system 100. In some examples, a hypervisor is implemented as a virtual machine manager. A hypervisor is a software module that provides and manages multiple virtual machines 106a-d executing in system memory 102, each virtual machine independently executing an instance of an operating system 108 designed for a uniprocessor environment. The term operating system as used herein can refer to any implementation of an operating system in a storage array system. Non-limiting examples can include a single threaded operating system or storage system controller firmware. The hypervisor 110 can abstract the underlying system hardware from the executing virtual machines 106a-d, allowing the virtual machines 106a-d to share access to the system hardware. In this way, the hypervisor can provide the virtual machines 106a-d shared access to the host device 126 and storage devices 128a-b coupled to host IOC 118 and SAS IOC 120, respectively. Each virtual machine 106a-d can operate independently, including a separate resource pool, dedicated memory allocation, and cache memory block. For example, the physical memory available in the memory device 102 can be divided equally among the running virtual machines 106a-d.

The storage array system 100 can include system firmware designed to operate on a uniprocessor controller. For example, the system firmware for the storage array system 100 can include a single threaded operating system that manages the software and hardware resources of the storage array system 100. Multiprocessing of the single threaded operating system can be achieved by respectively executing separate instances of the uniprocessor operating system 108a-d in the separate virtual machines 106a-d. Each virtual machine can be respectively executed by a separate processor 104a-d. As each virtual machine 106a-d runs on a single processor, each virtual machine 106a-d executing an instance of the uniprocessor operating system 108a-d can handle I/O operations with host device 126 and storage devices 128a-b coupled via host IOC 118 and SAS IOC 120 in parallel with the other virtual machines. When I/O communication arrives from a connected device to an individual virtual machine, the I/O data can be temporarily stored in the cache memory of the recipient virtual machine.

The host IOC 118 and the SAS IOC 120 can support sr-IOV. To communicate with host devices 120a-b, 122, and 124, the hypervisor 110 can assign each of the virtual machines a respective virtual function provided by the host IOC 118 and SAS IOC 120. The virtual function is an sr-IOV primitive that can be used to share a single 10 controller across multiple virtual machines. Thus, the SAS IOC 120 can be shared across virtual machines 106a-d using virtual functions. Even though access to SAS IOC 120 is shared, each virtual machine 106a-d operates as if it has complete access to the SAS IOC 120 via the virtual functions.

As mentioned above, SAS IOC 120 can be used to couple storage devices 128a-b, such as hard drives, to storage array system 100. Resources from one or more storage devices 128a-b coupled to SAS IOC 120 can be provisioned and presented to the virtual machines 106a-d as logical volumes 112a-d. Thus, each logical volume 112, the coordinates of which can exist in memory space in the memory device 102, can be assigned to the virtual machines 106 and associated with aggregated storage resources from storage devices 128a-b coupled to the SAS IOC 120. A storage device, in some aspects, can include a separate portion of addressable space that identifies physical memory blocks. Each logical volume 112 assigned to the virtual machines 106 can be mapped to the separate addressable memory spaces in the coupled storage devices 128a-b. The logical volumes 112a-d can thus map to a collection of different physical memory locations from the storage devices. For example, logical volume 112a assigned to virtual machine 106a can map to addressable memory space from two different storage devices 128a-b coupled to SAS IOC 120. Since the logical volumes 112a-d are not tied to any particular host device, the logical volumes 112a-d can be resized as required, allowing the storage system 100 to flexibly map the logical volumes 112a-d to different memory blocks from the storage devices 128a-b.

Each logical volume 112a-d can be identified to the assigned virtual machine using a different logical unit number (“LUN”). By referencing an assigned LUN, a virtual machine can access resources specified by a given logical volume. While logical volumes 112 are themselves virtual in nature as they abstract storage resources from multiple host devices, each assigned virtual machine “believes” it is accessing a physical volume. Each virtual machine 106a-d can access the resources referenced in assigned logical volumes 112a-d by accessing respectively assigned virtual functions. Specifically, each virtual function enables access to the SAS IOC 120. The SAS IOC 120 provides the interconnect to access the coupled storage devices.

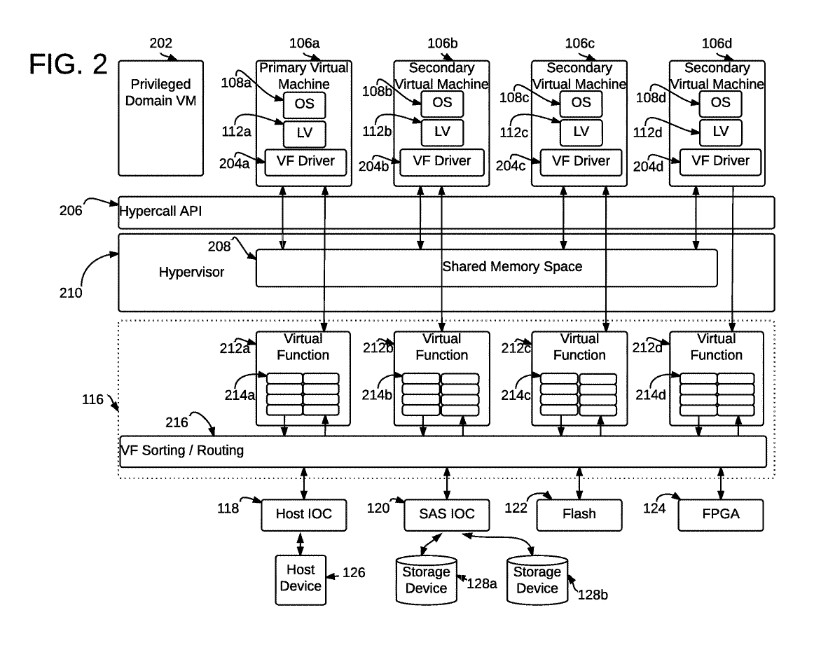

FIG. 2 depicts a block diagram illustrating an example of the hardware-software interface architecture of the storage array system 100. The exemplary hardware-software interface architecture depicts the assignment of virtual machines 106a-d to respective virtual functions. The hardware-software interface architecture shown in FIG. 2 can provide a storage array system capability for multiprocessing I/O operations to and from shared storage devices (e.g., solid state drives hard disk drive, etc.) and host devices communicatively coupled to the storage array system via SAS IOC 120 and host IOC 118, respectively. Multiprocessing of the I/O operations with coupled host device 126 and storage devices 128a-b can be achieved by running multiple instances of the uniprocessor operating system 108a-d (e.g., the storage array system operating system) on independently executing virtual machines 106a-d, as also depicted in FIG. 1. Each virtual machine 106a-d can include a respective virtual function driver 204a-d. Virtual function drivers 204a-d provide the device driver software that allows the virtual machines 106a-d to communicate with an SR-IOV capable I/O controller, such as host IOC 118 or SAS IOC 120. The virtual function drivers 204a-d allow each virtual machine 106a-d to communicate with a respectively assigned virtual function 212a-d. Each virtual function driver 204a-d can include specialized code to provide full access to the hardware functions of the host IOC 118 and SAS IOC 120 via the respective virtual function. Accordingly, the virtual function drivers 204a-d can provide the virtual machines 106a-d shared access to the connected host device 126 and storage devices 128a-b.

The storage array system can communicate with host device 126 and storage devices 128a-b via a virtual function layer 116. The virtual function layer 116 includes a virtual function sorting/routing layer 216 and virtual functions 212a-d. Each virtual function 212a-d can include virtualized base address registers 214a-d. A virtual machine manager/hypervisor 210 (hereinafter “hypervisor) can initiate the virtual machines 106a-d and manage the assignment of virtual functions 212a-d to virtual machines 106a-d, respectively.

A non-limiting example of a hypervisor 210 is a Xen virtual machine manager. As the hypervisor 210 boots, it can instantiate a privileged domain virtual machine 202 owned by the hypervisor 210. The privileged domain virtual machine 202 can have specialized privileges for accessing and configuring hardware resources of the storage array system. For example, the privileged domain virtual machine 202 can be assigned to the physical functions of the host IOC 118 and SAS IOC 120. Thus, privileged domain virtual machine 202 can access a physical function and make configuration changes to a connected device (e.g., resetting the device or changing device specific parameters). Because the privileged domain virtual machine 202 may not perform configuration changes of host IOC 118 and SAS IOC 120 concurrently with I/O access of the host device 126 and storage devices 128a-b, assigning the physical functions of the sr-IOV capable IOCs to the privileged domain virtual machine 202 does not degrade I/O performance. A non-limiting example of the privileged domain virtual machine 202 is Xen Domain 0, a component of the Xen virtualization environment.

After the privileged domain virtual machine 202 initializes, the hypervisor 210 can initiate the virtual machines 106a-d by first instantiating a primary virtual machine 106a. The primary virtual machine 106a can instantiate instances of secondary virtual machines 106b-d. The primary virtual machine 106a and secondary virtual machines 106b-d can communicate with the hypervisor 210 via a hypercall application programming interface (API) 206.

Once each virtual machine 106 is initialized, the primary virtual machine 106a can send status requests or pings to each of the secondary virtual machines 106b-d to determine if the secondary virtual machines 106b-d are still functioning. If any of the secondary virtual machines 106b-d have failed in operation, the primary virtual machine 106a can restart the failed secondary virtual machine. If the primary virtual machine 106a fails in operation, the privileged domain virtual machine 202 can restart the primary virtual machine 106a. The primary virtual machine 106a can also have special privileges related to system configuration. For example, in some aspects, the FPGA 124 can be designed such that registers of the FPGA 124 cannot be shared among multiple hosts. In such an aspect, configuration of the FPGA 124 can be handled by the primary virtual machine 106a. The primary virtual machine 106a can also be responsible for managing and reporting state information of the host IOC 118 and the SAS IOC 120, coordinating Start Of Day handling for the host IOC 118 and SAS IOC 120, managing software and firmware upgrades for the storage array system 100, and managing read/write access to a database Object Graph (secondary virtual machines may have read-only access to the database Object Graph).

The hypervisor 210 can also include shared memory space 208 that can be accessed by the primary virtual machine 106a and secondary virtual machines 106b-d, allowing the primary virtual machine 106a and secondary virtual machines 106b-d to communicate with each other.

Each of the primary virtual machine 106a and secondary virtual machines 106b-d can execute a separate instance of the uniprocessor storage operating system 108a-d. As the uniprocessor operating system 108 is designed to operate in an environment with a single processing device, each virtual machine 106a-d can be assigned to a virtual central processing unit (vCPU), and the vCPU can either be assigned to a particular physical processor (e.g., among the processors 104a-d shown in FIG. 1) for maximizing performance or can be scheduled using the hypervisor 210 to run on any available processor depending on the hypervisor scheduling algorithm, where performance may not be a concern.

Each host device 126 and storage device 128a-b can be virtualized via SR-IOV virtualization. As mentioned above, SR-IOV virtualization allows all virtual machines 106a-d to have shared access to each of the connected host device 126, and storage devices 128a-b. Thus, each virtual machine 106a-d, executing a respective instance of the uniprocessor operating system 108a-d on a processor 104a-d, can share access to connected host device 126 and storage devices 128a-b with each of the other virtual machines 106a-d in parallel. Each virtual machine 106a-d can share access among connected host device 126 and storage devices 128a-b in a transparent manner, such that each virtual machine 106a-d “believes” it has exclusive access to the devices. Specifically, a virtual machine 106 can access host device 126 and storage devices 128a-b independently without taking into account parallel access from the other virtual machines. Thus, virtual machine 106 can independently access connected devices without having to reprogram the executing uniprocessor operating system 108 to account for parallel I/O access. For example, the hypervisor 210 can associate each virtual machine 106a-d with a respective virtual function 212a-d. Each virtual function 212a-d can function as a handle to virtual instances of the host device 126 and storage devices 128a-b.

For example, each virtual function 212a-d can be associated with one of a set of virtual base address registers 214a-d to communicate with storage devices 128a-b. Each virtual function 212a-d can have its own PCI-e address space. Virtual machines 106a-d can communicate with storage devices 128a-b by reading to and writing from the virtual base address registers 214a-d. The virtual function sorting/routing layer 216 can map virtual base address registers 214a-d of each virtual function 212a-d to physical registers and memory blocks of the connected host devices 120a-b, 122, and 124. Once a virtual machine 106 is assigned a virtual function 212, the virtual machine 106 believes that it “owns” the storage device 128 and direct memory access operations can be performed directly to/from the virtual machine address space. Virtual machines 106a-d can access host device 126 in a similar manner.

For example, to communicate with the storage drives 128a-b coupled with the SAS IOC 120, the virtual machine 106a can send and receive data via the virtual base address registers 214a included in virtual function 212a. The virtual base address registers 214a point to the correct locations in memory space of the storage devices 128a-b or to other aspects of the IO path, as mapped by the virtual function sorting/routing layer 216. While virtual machine 106a accesses storage device 128a, virtual machine 106b can also access storage device 128b in parallel. Virtual machine 106b can send and receive data to and from the virtual base address registers 214b included in virtual function 212b. The virtual function sorting/routing layer 216 can route the communication from the virtual base address registers 214b to the storage device 128b. Further, secondary virtual machine 106c can concurrently access resources from storage device 128a by sending and receiving data via the virtual base address registers 214c included in virtual function 212c. Thus, all functionality of the storage devices 128a-b can be available to all virtual machines 106a-d through the respective virtual functions 212a-d. In a similar manner, the functionality of host device 126 can be available to all virtual machines 106a-d through the respective virtual functions 212a-d.

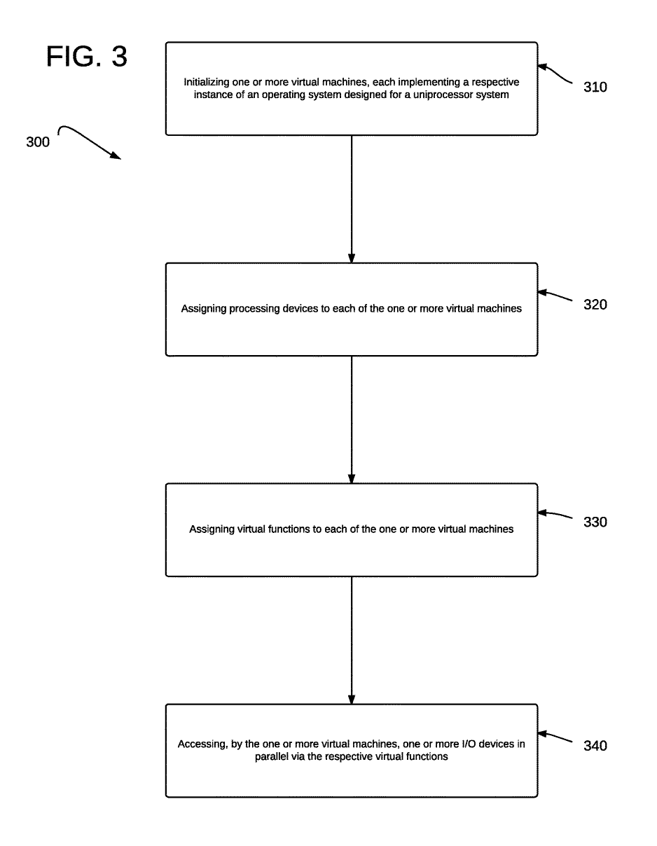

FIG. 3 shows a flowchart of an example method 300 for allowing a multiprocessor storage system running a uniprocessor operating system to provide each processor shared access to multiple connected host devices. For illustrative purposes, the method 300 is described with reference to the devices depicted in FIGS. 1-2. Other implementations, however, are possible.

The method 300 involves, for example, initializing, in a multiprocessor storage system, one or more virtual machines, each implementing a respective instance of an storage operating system designed for a uniprocessor environment, as shown in block 310. For example, during system boot up of storage array system 100 shown in FIG. 1, the hypervisor 210 can instantiate a primary virtual machine 106a that executes an instance of the uniprocessor operating system 108a. The uniprocessor operating system 108 can be a single threaded operating system designed to manage I/O operations of connected host devices in a single processor storage array. In response to the primary virtual machine 106a initializing, the storage array system 100 can initiate secondary virtual machines 106b-d. For example, the primary virtual machine 106a can send commands to the hypercall API 206, instructing the hypervisor 210 to initiate one or more secondary virtual machines 106b-d. Alternatively, the hypervisor 210 can be configured to automatically initiate a primary virtual machine 106a and a preset number of secondary virtual machines 106b-d upon system boot up. As the virtual machines 106 are initialized, the hypervisor 210 can allocate cache memory to each virtual machine 106. Total cache memory of the storage array system can be split across each of the running virtual machines 106.

The method 300 can further involve assigning processing devices in the multiprocessor storage system to each of the one or more virtual machines 106, as shown in block 320. For example the storage array system 100 can include multiple processing devices 104a-d in the form of a single ASIC hosting multiple processing cores or in the form of multiple ASICs each hosting a single processing core. The hypervisor 210 can assign the primary virtual machine 106a a vCPU, which can be mapped to one of the processing devices 104a-d. The hypervisor 210 can also assign each secondary virtual machine 106b-d to a respective different vCPU, which can be mapped to a respective different processing device 104. Thus, I/O operations performed by multiple instances of the uniprocessor operating system 108 running respective virtual machines 106a-d can be executed by processing devices 104a-d in parallel.

The method 300 can also involve providing virtual functions to each of the one or more virtual machines, as shown in block 330. For example, a virtual function layer 116 can maintain virtual functions 212a-d. The hypervisor 210 can assign each of the virtual functions 212a-d to a respective virtual machine 106a-d. To assign the virtual functions 212a-d virtual machines 106a-d, the hypervisor 210 can specify the assignment of PCI functions (virtual functions) to virtual machines in a configuration file included as part of the hypervisor 210 in memory. By assigning each virtual machine 106a-d with a respective virtual function 212a-d, the virtual machines 106a-d can access resources in attached I/O devices (e.g., attached sr-IOV capable host devices and storage devices). For example, the multiprocessor storage system can access one or logical volumes that refer to resources in attached storage devices, each logical volume identified by a logical unit number (“LUN”). A LUN allows a virtual machine to identify disparate memory locations and hardware resources from connected host devices by grouping the disparate memory locations and hardware resources as a single data storage unit (a logical volume).

Each virtual function 212a-d can include virtual base address registers 214a-d. To communicate with connected host devices 126 and storage devices 128a-b, the hypervisor 210 can map the virtual base address registers 214a-d to physical registers in connected host IOC 118 and SAS IOC 120. Each virtual machine can access connected devices via the assigned virtual function. By writing to the virtual base address registers in a virtual function, a virtual machine has direct memory access streams to connected devices.

The method 300 can further include accessing, by the one or more virtual machines, one or more of the host devices or storage devices in parallel via the respective virtual functions, as shown in block 340. As each processing device 104a-d can respectively execute its own dedicated virtual machine 106a-d and each virtual machine 106a-d runs its own instance of the uniprocessor operating system 108, I/O operations to and from connected host device 126 and storage devices 128a-b can occur in parallel. For example, to communicate with a host device 126 or a storage device 128a-b, a virtual machine 106 can access the virtual base address registers 214 in the assigned virtual function 212. The virtual function sorting/routing layer 216 can route the communication from the virtual function 212 to the appropriate host device 126 or storage device 128. Similarly, to receive data from a host device 126 or storage device 128a-b, the virtual machine 106 can read data written to the virtual base address registers 214 by the connected host device 126 or the storage devices 128a-b. Utilization of virtual functions 212a-d and the virtual function sorting/routing layer 216 can allow the multiprocessor storage system running a single threaded operating system to share access to connected devices without resulting in conflicting access to the underlying data structures. For example, different processors in the multiprocessor storage system, each executing instances of a uniprocessor storage operating system 108, can independently write to the assigned virtual functions 106 in parallel. The virtual function sorting/routing layer 216 can sort the data written into each set of base address registers 214 and route the data to unique memory spaces of the physical resources (underlying data structures) of the connected host device 126 and storage devices 128a-b.

Providing virtual machines parallel shared access to multiple host devices, as described in method 300, allows a multiprocessor storage system running a single threaded operating system to flexibly assign and migrate connected storage resources in physical storage devices among the executing virtual machines. For example, virtual machine 106a can access virtual function 212a in order to communicate with aggregated resources of connected host device storage devices 128a-b. The aggregated resources can be considered a logical volume 112a. The resources of storage devices 128a-b can be portioned across multiple logical volumes. In this way, each virtual machine 106a-d can be responsible for handling I/O communication for specified logical volumes 112a-d in parallel (and thus access hardware resources of multiple connected host devices in parallel). A logical volume can be serviced by one virtual machine at any point in time. For low I/O loads or in a case where the queue depth per LUN is small, a single virtual machine can handle all I/O requests. During low I/O loads, a single processing device can be sufficient to handle I/O traffic. Thus, for example, if the storage array system 100 is only being accessed for minimal I/O operation (e.g., via minimal load on SAS IOC 120 and host IOC 118), a single virtual machine can handle the I/O operations to the entire storage array. As I/O load on the storage array system 100, and specifically load on the host IOC 118 or SAS IOC 120 increases and passes a pre-defined threshold, a second virtual machine can be initiated and the I/O load can be dynamically balanced among the virtual machines.

To dynamically balance I/O load from a first running virtual machine to a second running virtual machine on the same controller, the logical volume of the first running virtual machine can be migrated to the second running virtual machine. For example, referring to FIG. 1, the logical volume 112a can be migrated from virtual machine 106a to virtual machine 106b. To migrate a logical volume across virtual machines, the storage array system first disables the logical volume, sets the logical volume to a write through mode, syncs dirty cache for the logical volume, migrates the logical volume to the newly initiated virtual machine, and then re-enables write caching for the volume.

In order to provide a multiprocessor storage system the capability to flexibly migrate logical volumes across virtual machines, while maintaining shared access to connected host devices, certain configuration changes to the logical volumes can be made. For example, as the storage array system 100 migrates the logical volume 112, the storage array system 100 also modifies target port group support (TPGS) states for the given logical volume 112. The TPGS state identifies, to a connected host device 126 (e.g., a connected host server), how a LUN can be accessed using a given port on the storage array system 100. Each virtual machine 106a-d has a path to and can access each logical volume 112a-d. The TPGS state of each logical volume 112a-d enables an externally connected host device 126 to identify the path states to each of the logical volumes 112a-d. If a virtual machine is assigned ownership of a logical volume, then the TPGS state of the logical volume as reported by the assigned virtual machine is “Active/Optimized.” The TPGS state of the logical volume as reported by the other running virtual machines within the same controller is reported as “Standby.” For example, a TPGS state of “Active/Optimized” indicates to the host device 126 that a particular path is available to send/receive I/O. A TPGS state of “Standby” indicates to the host device 126 that the particular path cannot be chosen for sending I/O to a given logical volume 112.

Thus, for example, referring to FIG. 2, if logical volume 112a is assigned to virtual machine 106a, then the TPGS state of the logical volume 112a as reported by virtual machine 106a is Active/Optimized, while the TPGS states of logical volume 112a as reported by virtual machines 106b-d are Standby. When migrating logical volume 112a to virtual machine 106b in a situation of increased load on virtual machine 106a, the system modifies the TPGS state of the logical volume 112a as reported by virtual machine 106a to Standby and modifies the TPGS state of the logical volume 112a as reported by virtual machine 106b to Active/Optimized. Modifying the TPGS states as reported by the running virtual machines thus allows the storage array system 100 to dynamically modify which virtual machine handles I/O operations for a given logical volume. Storage system controller software executing in the virtual machines 106a-d and/or the virtual machine manager 110 can modify the TPGS state of each logical volume 112a-d.

As additional virtual machines can be spawned and deleted based on varying I/O loads, a cache reconfiguration operation can be performed to re-distribute total cache memory among running virtual machines. For example, if the current I/O load on a virtual machine increases past a certain threshold, the primary virtual machine 106a can initiate a new secondary virtual machine 106b. In response to the new secondary virtual machine 106b booting up, the hypervisor 210 can temporarily quiesce all of the logical volumes 112 running in the storage array system 100, set all logical volumes 112 to a Write Through Mode, sync dirty cache for each initiated virtual machine 106a-b, re-distribute cache among the initiated virtual machines 106a-b, and then re-enable write back caching for all of the logical volumes 112.

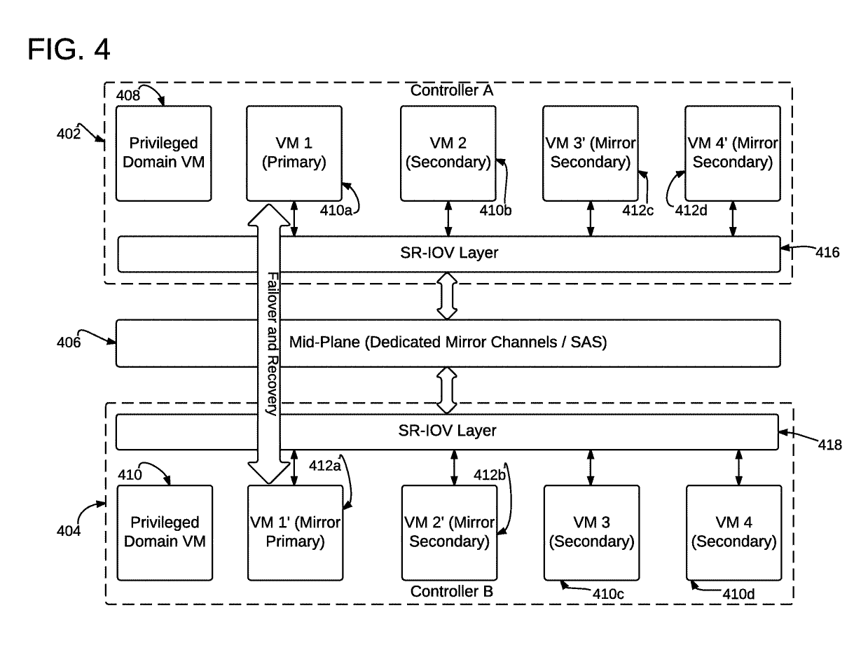

In some embodiments, a storage array system can include multiple storage system controller boards, each supporting a different set of processors and each capable of being accessed by multiple concurrently running virtual machines. FIG. 4 is a block diagram depicting an example of controller boards 402, 404, each with a respective SR-IOV layer 416, 418. A storage array system that includes the controller boards 402, 404 can include, for example, eight processing devices (e.g., as eight processing cores in a single ASIC or eight separate processing devices in multiple ASICs). In a system with multiple controller boards, a portion of the available virtualization space can be used for failover and error protection by mirroring half of the running virtual machines on the alternate controller board. A mid-plane layer 406 can include dedicated mirror channels and SAS functions that the I/O controller boards 402, 404 can use to transfer mirroring traffic and cache contents of virtual machines among the controller boards 402, 404. A mirror virtual machine can thus include a snapshot of a currently active virtual machine, the mirror virtual machine ready to resume operations in case the currently active virtual machine fails.

For example, as shown in FIG. 4, controller board 402 can include a sr-IOV layer 416 with a hypervisor that launches a privileged domain virtual machine 408 upon system boot up. Similarly, a second controller board 404 can include its own sr-IOV layer 418 with a hypervisor that launches a second privileged domain virtual machine 410 upon system boot up. Also on system boot up, the hypervisor for controller 402 can initiate a primary virtual machine 410a. In response to the controller 402 launching primary virtual machine 410a, the second controller 404, through the mid-plane layer 406, can mirror the image of primary virtual machine 410a as mirror primary virtual machine 412a. After initiating the mirror virtual machine 412a, upon receiving new I/O requests at the primary virtual machine 410a from an external host device, contents of the user data cache for the primary virtual machine 410a are mirrored to the cache memory that is owned by the mirror virtual machine 412a. The primary virtual machine 410a and the mirror primary virtual machine 412a can each be assigned to a separate physical processing device (not shown). The actively executing virtual machine (such as primary virtual machine 410a) can be referred to as an active virtual machine, while the corresponding mirror virtual machine (such as mirror primary virtual machine 412a) can be referred to as an inactive virtual machine.

The primary virtual machine 410a can initiate a secondary virtual machine 410b that is mirrored as mirror secondary virtual machine 412b by second controller 404. For example, cache contents of secondary virtual machine 410b can be mirrored in alternate cache memory included in mirror secondary virtual machine 412b. Active virtual machines can also run on secondary controller 404. For example, third and fourth virtual machines (secondary virtual machines 410c-d) can be initiated by the hypervisor in virtual function layer 418. In some aspects, the primary virtual machine 410a running on controller 402 can initiate secondary virtual machines 410c-d. The mirror instances of secondary virtual machines 410c-d can be respectively mirrored on controller 402 as mirror secondary virtual machine 412c and mirror secondary virtual machine 412d. Each of the virtual machines 410, 412a-d can be mirrored with virtual machines 408, 410a-d, respectively, in parallel. Parallel mirror operations are possible because each virtual machine 408, 410a-d can access the SAS IOC on the controller board 402 using sr-IOV mechanisms.

The active virtual machines (e.g., primary virtual machine 410a, secondary virtual machines 410b-d) can handle I/O operations to and from host devices connected to the storage array system. Concurrently, each inactive virtual machine (e.g., mirror primary virtual machine 412a, mirror secondary virtual machines 412b-d) can duplicate the cache of the respective active virtual machine in alternate cache memory. Thus, mirror virtual machine 412a can be associated with the LUNs (assigned to the same logical volumes) as primary virtual machine 410a. In order to differentiate between active virtual machines and inactive mirror virtual machines, the TPGS state of a given logical volume can be set to an active optimized state for the active virtual machine and an active non-optimized state for the inactive mirror virtual machine. In response to the active virtual machine failing in operation, the TPGS state of the logical volume is switched to active optimized for the mirror virtual machine, allowing the mirror virtual machine to resume processing of I/O operations for the applicable logical volume via the alternate cache memory.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

Some embodiments described herein may be conveniently implemented using a conventional general purpose or a specialized digital computer or microprocessor programmed according to the teachings herein, as will be apparent to those skilled in the computer art. Some embodiments may be implemented by a general purpose computer programmed to perform method or process steps described herein. Such programming may produce a new machine or special purpose computer for performing particular method or process steps and functions (described herein) pursuant to instructions from program software. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art would understand that information may be represented using any of a variety of different technologies and techniques.

Some embodiments include a computer program product comprising a computer readable medium (media) having instructions stored thereon/in and, when executed (e.g., by a processor), perform methods, techniques, or embodiments described herein, the computer readable medium comprising instructions for performing various steps of the methods, techniques, or embodiments described herein. The computer readable medium may comprise a non-transitory computer readable medium. The computer readable medium may comprise a storage medium having instructions stored thereon/in which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

The various illustrative logical blocks, modules, and circuits described in connection with the embodiments disclosed herein may be implemented or performed with a general-purpose processing device, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processing device may be a microprocessor, but in the alternative, the processor may be any conventional processor, controller, microcontroller, or state machine. A processing device may also be implemented as a combination of computing devices, e.g., a combination of a DSP and a microprocessor, a plurality of microprocessors, one or more microprocessors in conjunction with a DSP core, or any other such configuration

Aspects of the methods disclosed herein may be performed in the operation of such processing devices. The order of the blocks presented in the figures described above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation and are not meant to be limiting.

While the present subject matter has been described in detail with respect to specific examples thereof, it will be appreciated that those skilled in the art, upon attaining an understanding of the foregoing may readily produce alterations to, variations of, and equivalents to such aspects and examples. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A method comprising:
initializing, in a multiprocessor storage system, a plurality of virtual machines each implementing a respective instance of a storage operating system designed for a uniprocessor environment;
respectively assigning processing devices to each of the plurality of virtual machines;
respectively assigning virtual functions to each of the plurality of virtual machines; and
accessing, by the plurality of virtual machines, one or more storage I/O devices in parallel via the respective virtual functions.

2. The method of claim 1, further comprising assigning each of the plurality of virtual machines one or more logical volumes managed by the storage system.

3. The method of claim 2, further comprising:
initializing an additional virtual machine in response to a first logical volume assigned to one of the plurality of virtual machines increasing in input/output load; and
migrating the first logical volume to the additional virtual machine by:
modifying a first state associated with the first logical volume to a standby mode for the one of the plurality of virtual machines, and
modifying a second state associated with the first logical volume to an active mode for the additional virtual machine.

4. The method of claim 1, wherein each of the plurality of virtual machines is allocated a respective cache memory, each respective cache memory distributed from a total cache memory.

5. The method of claim 4, wherein one of the plurality of virtual machines is included on a primary controller and associated with a respective mirror virtual machine included on a secondary controller, and wherein the respective mirror virtual machine is allocated an alternate cache memory that mirrors the cache memory allocated to the one of the plurality of virtual machines.

6. The method of claim 5, wherein the respective mirror virtual machine resumes execution of the instance of the operating system via the alternate cache memory when the one of the plurality of virtual machines fails in operation.

7. The method of claim 2, wherein a first virtual machine of the plurality of virtual machines is a primary virtual machine, and wherein the primary virtual machine is configured to initialize additional virtual machines, wherein each additional virtual machine is assigned an additional processing device.

8. The method of claim 1, wherein:
the respective virtual functions comprise respective virtualized base address registers, and
each of the plurality of virtual machines communicates with the one or more storage I/O devices by writing to, and reading from, the respective virtualized base address registers of the virtual functions respectively allocated to the plurality of virtual machines.

9. A computing device comprising:
a memory containing machine readable medium comprising machine executable code having stored thereon instructions for performing a method of running an operating system designed for a uniprocessor environment on a multiprocessor storage system; and
a plurality of processors coupled to the memory, the plurality of processors configured to execute the machine executable code to cause the plurality of processors to:
initiate a first virtual machine executing a first instance of the operating system designed for a uniprocessor environment, wherein the first virtual machine is assigned to a first virtual function,
initiate a second virtual machine executing a second instance of the operating system, wherein the second virtual machine is assigned to a second virtual function,
wherein the first virtual machine and the second virtual machine share access to one or more storage I/O devices in parallel via the first virtual function and the second virtual function,
wherein a first processing device of the plurality of processing devices is configured to execute operations performed by the first virtual machine, and
wherein a second processing device of the plurality of processing devices is configured to execute operations performed by the second virtual machine.

10. The computing device of claim 9, wherein:
the first virtual machine is assigned one or more first logical volumes of the computing device, and
the second virtual machine is assigned to one or more second logical volumes of the computing device by the first virtual machine.

11. The computing device of claim 10, wherein:
the first virtual machine is configured to initialize an additional virtual machine and migrate the second logical volume to the additional virtual machine in response to the first virtual machine increasing in input/output load, and
the first virtual machine is configured to migrate the second logical volume to the additional virtual machine by modifying a first state associated with the second logical volume to a standby mode for the second virtual machine and modifying a second state associated with the second logical volume to an active mode for the additional virtual machine.

12. The computing device of claim 9, wherein:
the first virtual machine is allocated a first cache memory and the second virtual machine is allocated a second cache memory, the first cache memory and the second cache memory distributed from a total cache memory.

13. The computing device of claim 12, wherein:
the first virtual machine and the second virtual machine are included on a first controller and are respectively associated with a first mirror virtual machine and a second mirror virtual machine included on a second controller,
the first mirror virtual machine and second mirror virtual machine are respectively allocated a first alternate cache memory and a second alternate cache memory, and
the first alternate cache memory and the second alternate cache memory respectively mirror the first cache memory and the second cache memory.

14. The computing device of claim 13, wherein:
the first mirror virtual machine is configured to handle storage I/O operations for the one or more first logical volumes assigned to the first virtual machine when the first virtual machine fails in operation via the first alternate cache memory, and
the second mirror virtual machine is configured to handle storage I/O operations for the one or more second logical volumes assigned to second virtual machine when the second virtual machine fails in operation via the second alternate cache memory.

15. The computing device of claim 10, wherein:
the first virtual machine is a primary virtual machine,
the primary virtual machine is configured to initialize additional virtual machines and manage the one or more first logical volumes and the one or more second logical volumes, and
each additional virtual machine is assigned to an additional processing device of the plurality of processing devices.

16. The computing device of claim 9, wherein:
the first virtual machine and the second virtual machine respectively include a first virtual function driver and a second virtual function driver, and
the first virtual function driver and the second virtual function driver are configured to respectively register the first virtual machine and the second virtual machine with the one or more storage I/O devices.

17. A non-transitory machine readable medium having stored thereon instructions for performing a method comprising machine executable code which when executed by at least one machine, causes the machine to:
initialize, in a multiprocessor storage system of the machine, a plurality of virtual machines each implementing a respective instance of a storage operating system designed for a uniprocessor environment;
respectively assign processing devices to each of the plurality of virtual machines;
respectively assign virtual functions to each of the plurality of virtual machines; and
accessing, by the plurality of virtual machines, one or more storage I/O devices in parallel via the respective virtual functions.

18. The non-transitory machine readable medium of claim 17, further comprising machine executable code that causes the machine to:
assign each of the plurality of virtual machines to one or more logical volumes.

19. The non-transitory machine readable medium of claim 18, further comprising machine executable code that causes the machine to:
initialize an additional virtual machine in response to a first logical volume assigned to one of the plurality of virtual machines increasing in input/output load; and
migrate the first logical volume to the additional virtual machine by:
modify a first state associated with the first logical volume to a standby mode for the one of the plurality of virtual machines, and
modify a second state associated with the first logical volume to an active mode for the additional virtual machine.

20. The non-transitory machine readable medium of claim 18, wherein:
a first virtual machine of the plurality of virtual machines is a primary virtual machine, and
the primary virtual machine is configured to initialize additional virtual machines and manage the respective logical volumes assigned to the plurality of virtual machines.
